(19) United States
(12) Patent Application Publication
(10) Pub. No.: US 2018/0281166 A1
(43) Pub. Date: Oct. 4, 2018

(54) Multi-piece Wrench and Screwdriver Tool

(71) Applicant: Erik Vaclav Chmelar, Ann Arbor, MI (US)

(72) Inventor: Erik Vaclav Chmelar, Ann Arbor, MI (US)

(21) Appl. No.: 15/944,781

(22) Filed: Apr. 3, 2018

Related U.S. Application Data
(60) Provisional application No. 62/480,545, filed on Apr. 3, 2017.

(51) Int. Cl. B25F 1/02; B25G 1/08; B25B 23/00; B25B 13/06; B25B 15/02; F21V 33/00; F21V 23/04

(52) U.S. Cl. CPC B25F 1/02; B25G 1/085; B25B 23/0035; B25F 1/04; B25B 15/02; F21V 33/0084; F21V 23/0414; B25B 13/06

(57) ABSTRACT

A multi-piece tool having an outer pair of tubes, an inner pair of tubes, and a screwdriver, all of which nest together axially for compact storage. The outer pair of tubes and inner pair of tubes respectively thread together at their proximal ends and have a plurality of open-end wrenches on their distal ends. The screwdriver comprises a removable double-ended shaft with a removable bit on each end. A laser pointer may be disposed within the first inner tube and a flashlight may be disposed within the second inner tube.

### CROSS-REFERENCE TO RELATED APPLICATIONS

This application is claims the benefit of provisional U.S. Pat. App. 62/480,545, filed Apr. 3, 2017. The disclosure of that application is incorporated herein by reference.

### BACKGROUND OF THE INVENTION

The several embodiments of this disclosure relate generally to multi-function compact hand tools, which are sometimes called “multi-tools.” Such multi-tools may include wrenches, sockets, screwdrivers, flashlights, laser pointers, knives, can or bottle openers, files, and other implements of varying purpose and utility.

Multi-tools may assume myriad forms, for example substantially flat as in U.S. Pat. No. 7,530,295; substantially T-shaped as in U.S. Pat. No. 2,445,905 or U.S. Pat. No. 6,279,434; articulating as in U.S. Pat. No. 4,238,862; or cylindrically nested as in U.S. Pat. No. 7,293,312. The several embodiments of this disclosure relate primarily to cylindrically nested multi-tools.

### BRIEF SUMMARY OF THE INVENTION

The several embodiments teach a new and useful compact multifunction hand tool. The first illustrated embodiment includes sixteen open-end wrenches, two sockets, four screwdriver tips, and six hex keys. The second illustrated embodiment has a laser pointer and an LED flashlight in place of the hex keys. These are merely two of many configurations of tool elements within the scope of this invention.

The total number of tool elements or implements may vary, for example, if components are omitted or if non-omitted components are configured differently. For example, a given end of an outer or inner tube may have more or less than the four open-end wrenches that are illustrated, which depends on the diameter(s) and/or wall thickness of the given end of the tube. Similarly, the hex keys unit may comprise different elements, for example knives, files, screwdriver bits, scissors, tweezers, electronic storage devices, or other elements that are sometimes adapted for use in articulating or fold-out multi-tools.

Any component, particularly those internal to the outer tubes, may instead comprise a laser pointer, flashlight (LED, incandescent, fluorescent, halogen, or otherwise), air-pressure gauge, telescoping magnet, ink pen or marker, whistle, electronic storage device, water (liquid) level, laser or infrared distance measuring device, ultraviolet light, calipers, flammable gas torch, lighter, tape measure, chisel, scraper, or pliers. For example, the screwdriver assembly of the several embodiments could instead be a telescoping magnet assembly, or one of the screwdriver bits could be a pencil, pen, or ink marker.

### BRIEF DESCRIPTION OF THE DRAWINGS

FIGS. 1a, 1b, and 1e are perspective, end elevation, and plan views, respectively, of a first embodiment showing all components nested for storage. FIGS. 1c and 1d are exploded perspective views thereof.

FIGS. 2a and 2b are cross-sectional plan and cross-sectional perspective views, respectively, taken along line A-A of FIG. 1b. FIG. 2c is an exploded plan view thereof.

FIG. 3 is a perspective view of an assembly showing the first and second outer wrench units.

FIG. 4 is a perspective view of an assembly showing the first and second inner wrench units.

FIG. 5 is a perspective view of an assembly showing the first outer wrench unit and the second inner wrench unit.

FIG. 6 is a perspective view of an assembly showing the second outer wrench unit and the first inner wrench unit.

FIG. 7 is a perspective view of an assembly showing the first outer wrench unit, the screwdriver shaft, and the second screwdriver bit.

FIG. 8a is a perspective view of an assembly showing the first and second hex keys units; FIG. 8b is a perspective view thereof showing the hex keys in arbitrary swiveled positions; and FIG. 8c is an exploded perspective view of the first and second hex keys units.

FIG. 9 is a perspective view of the tool of FIG. 1a having knurling on the narrow regions of the first and second outer wrench units.

FIGS. 10a, 10b, and 10e are perspective, end elevation, and plan views, respectively, of a second embodiment showing all components nested for storage. FIGS. 10c and 10d are exploded perspective views thereof.

FIGS. 11a and 11b are cross-sectional plan and cross-sectional perspective views, respectively, taken along line B-B of FIG. 10b. FIG. 11c is an exploded plan view thereof.

FIGS. 12a and 12b are perspective views of an assembly showing the first and second inner wrench units and the laser and flashlight units press-fit therein.

FIGS. 13a and 13b are exploded perspective views of the flashlight unit.

FIGS. 14a and 14b are exploded perspective views of the laser unit.

### DETAILED DESCRIPTION OF THE INVENTION

The following numerals are used to identify the corresponding elements in the figures. Two-digit numbers refer to assemblies. Three-digit numbers refer to components and their respective elements: 100- and 200-level numbers reference the first outer wrench unit 100 and second outer wrench unit 200, respectively; 300- and 400-level numbers reference the first inner wrench unit 300 and second inner wrench unit 400, respectively; 500- and 600-level numbers reference the first hex keys unit 500 and second hex keys unit 600, respectively; 700- and 800-level numbers reference the first screwdriver bit 700 and second screwdriver bit 800, respectively; 900-level numbers reference the screwdriver shaft 900; 1100- and 1200-level numbers reference the flashlight unit 1100 and laser unit 1200, respectively.
10 tool assembly
20 outer wrench assembly
30 inner wrench assembly without laser and flashlight
34 inner wrench assembly with laser and flashlight
40 hex keys unit assembly
50 screwdriver assembly
60 first outer and second inner wrenches assembly
70 second outer and first inner wrenches assembly
100 first outer wrench unit
110 proximal end of first outer wrench unit
112 male thread of first outer wrench unit
114 annular groove of first outer wrench unit
115 o-ring of first outer wrench unit
116 channel slot of first outer wrench unit
118 through hole of first outer wrench unit
120 distal end of first outer wrench unit
122 wrench opening of first outer wrench unit
124 wrench face of first outer wrench unit
130 through bore of first outer wrench unit
140 knurling of first outer wrench unit
200 second outer wrench unit
210 proximal end of second outer wrench unit
212 female thread of second outer wrench unit
220 distal end of second outer wrench unit
222 wrench opening of second outer wrench unit
224 wrench face of second outer wrench unit
230 through bore of second outer wrench unit
240 knurling of first outer wrench unit
300 first inner wrench unit
310 proximal end of first inner wrench unit
312 male thread of first inner wrench unit
314 first annular groove of first inner wrench unit
315 first o-ring of first inner wrench unit
316 second annular groove of first inner wrench unit
317 second o-ring of first inner wrench unit
320 distal end of first inner wrench unit
322 wrench opening of first inner wrench unit
324 wrench face of first inner wrench unit
330 through bore of first inner wrench unit
340 button hole of first inner wrench unit
342 button of first inner wrench unit
400 second inner wrench unit
410 proximal end of second inner wrench unit
412 female thread of second inner wrench unit
414 annular groove of second inner wrench unit
415 o-ring of second inner wrench unit
420 distal end of second inner wrench unit
422 wrench opening of second inner wrench unit
424 wrench face of second inner wrench unit
430 through bore of second inner wrench unit
440 button hole of first inner wrench unit
442 button of first inner wrench unit
500 first hex keys unit
510 proximal end of first hex keys unit
512 male thread of first hex keys unit
514 annular groove of first hex keys unit
515 o-ring of first hex keys unit
520 distal end of first hex keys unit
522 flange of first hex keys unit
530 cavity of first hex keys unit
532 hex key of first hex keys unit
534 swivel pin of first hex keys unit
600 second hex keys unit
610 proximal end of second hex keys unit
612 female thread of second hex keys unit
614 annular groove of second hex keys unit
615 o-ring of second hex keys unit
620 distal end of second hex keys unit
622 flange of second hex keys unit
630 cavity of second hex keys unit
632 hex key of second hex keys unit
634 swivel pin of second hex keys unit
700 first screwdriver bit
710 hexagonal body of first screwdriver bit
720 first tip of first screwdriver bit
730 second tip of first screwdriver bit
740 ball detent of first screwdriver bit
800 second screwdriver bit
810 hexagonal body of second screwdriver bit
820 first tip of second screwdriver bit
830 second tip of second screwdriver bit
840 ball detente of second screwdriver bit
900 screwdriver shaft
910 first hexagonal bore of screwdriver shaft
920 second hexagonal bore of screwdriver shaft
930 tab of screwdriver shaft
940 ball detent of screwdriver shaft
1100 flashlight unit
1110 bulb hole of flashlight unit
1120 button hole of flashlight unit
1122 button of flashlight unit
1130 cavity of flashlight unit
1132 end cap of flashlight unit
1134 male thread of flashlight unit
1136 female thread of flashlight unit
1140 electronics assembly of flashlight unit
1142 bulb of flashlight unit
1144 electronic push button switch of flashlight unit
1146 battery of flashlight unit
1148 electric lead of flashlight unit
1200 laser unit
1210 laser hole of laser unit
1220 button hole of laser unit
1222 button of laser unit
1230 cavity of laser unit
1232 end cap of laser unit
1234 male thread of laser unit
1236 female thread of laser unit
1240 electronics assembly of laser unit
1242 laser of laser unit
1244 electronic push button switch of laser unit
1246 battery of laser unit
1248 electric lead of laser unit

The illustrated embodiments are shown with exemplary means for coupling of various components to form assemblies. However, these means for coupling can be altered or adapted to meet functional, aesthetic, or cost constraints. Equivalent or interchangeable means for coupling may include the following:
complementary male and female threaded portions;
magnets and magnetic fields;
frictional fit between male and female portions with or without o-rings;
male and female plug-and-coupler connectors;
bayonet-lug connectors;
detent locks employing a spring-loaded ball, ring, leaf, pin, or cantilever; and
spring or ball plungers.

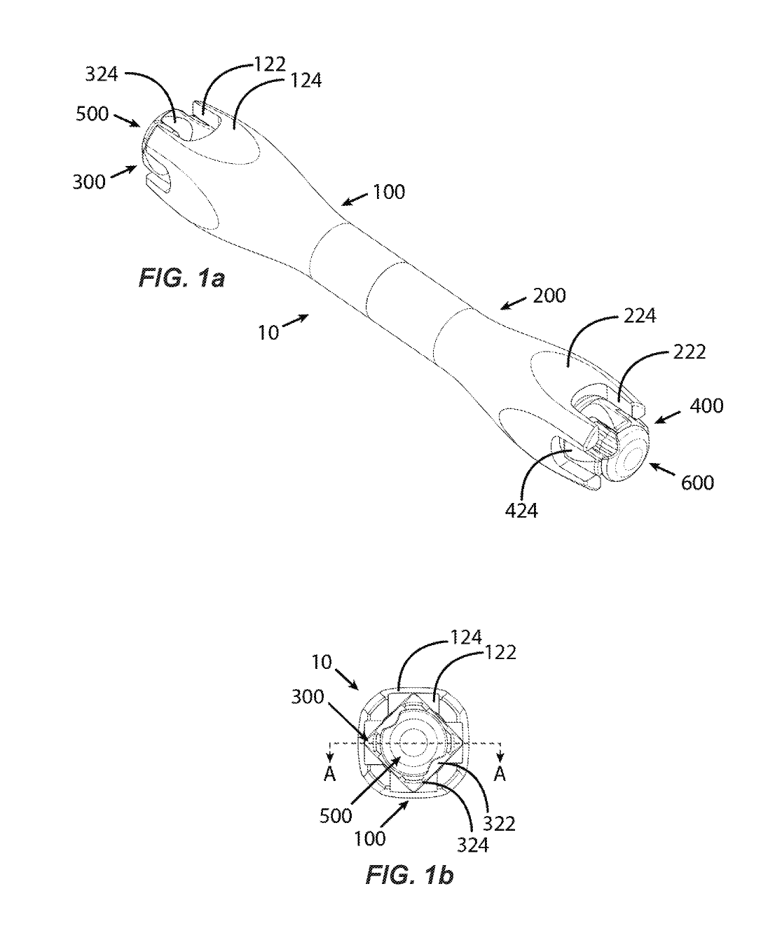

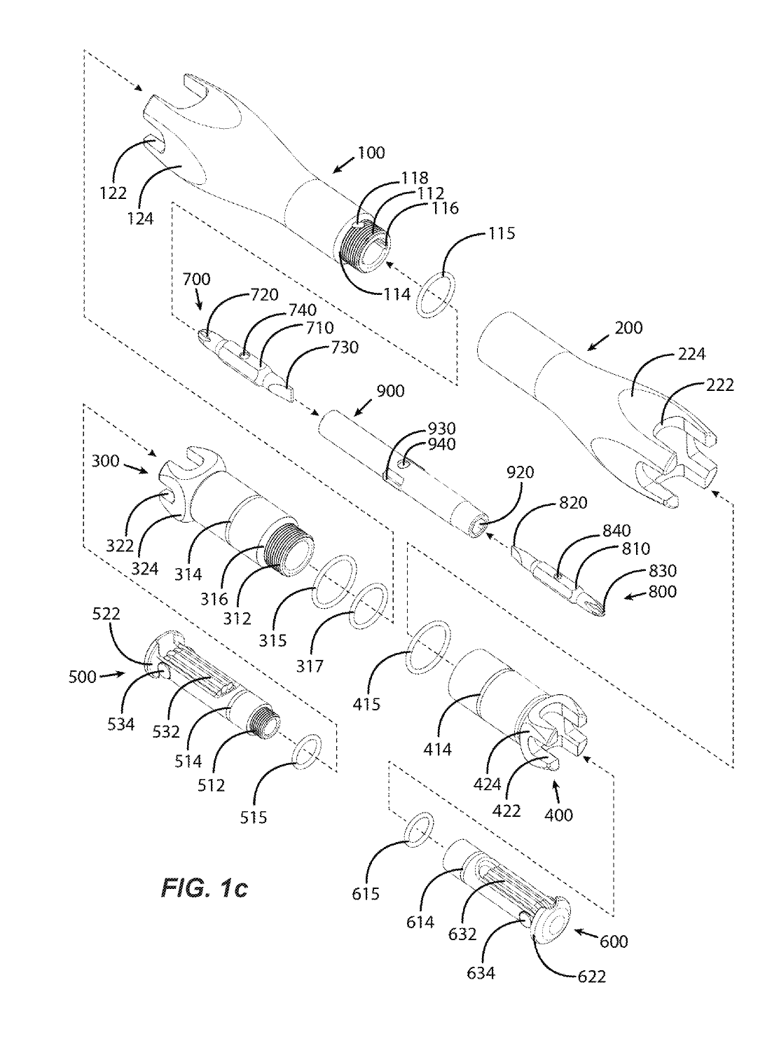

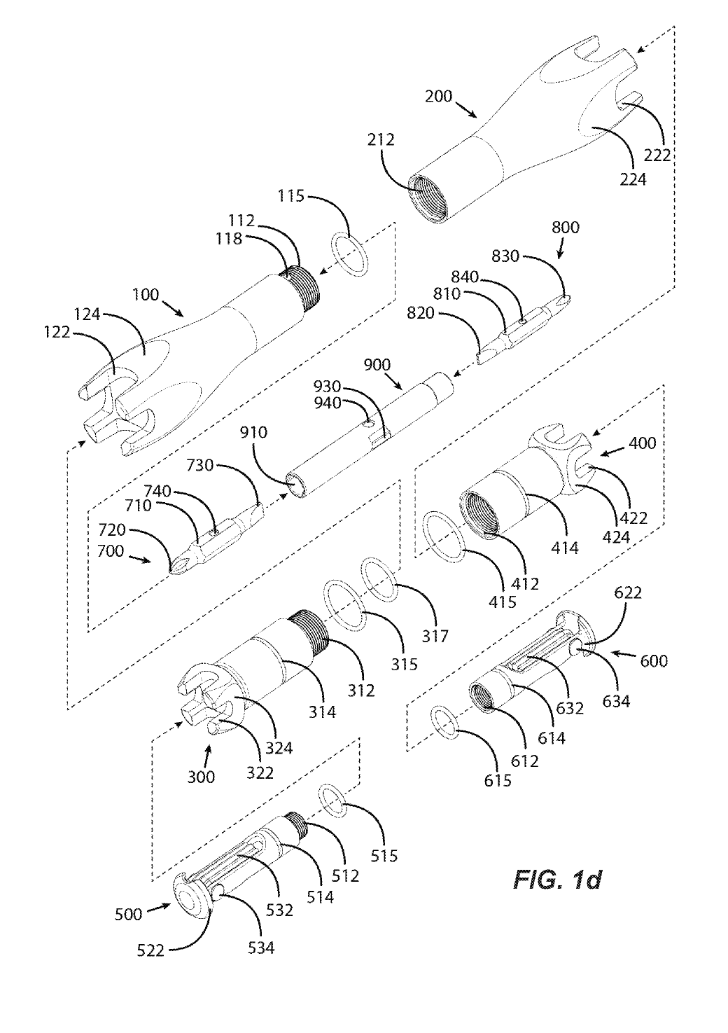

FIG. 1a shows a first embodiment of the tool assembly 10 in a fully nested configuration. A generally tubular first hex keys unit 500 is nested within a through bore of first inner wrench unit 330 of a generally tubular first inner wrench unit 300 which is in turn nested within a through bore of first outer wrench unit 130 of a generally tubular first outer wrench unit 100. Similarly, a generally tubular second hex keys unit 600 is nested within a through bore of second inner wrench unit 430 generally tubular second inner wrench unit 400 which is in turn nested within a through bore of second outer wrench unit 230 generally tubular second outer wrench unit 200.

FIG. 1b shows an end elevation of the fully nested tool assembly 10 wherein the first hex keys unit 500 nested within the first inner wrench unit 300 which is in turn nested within the first outer wrench unit 100.

The generally tubular nested units may have any arbitrary cross-sectional interior and exterior profiles, for example circular (as illustrated), elliptical, square, rectangular, triangular, and so on. The cross-sectional profile of the tubular units need not correspond with any particular coupling means, for example a unit's outer cross-sectional profile along most of the length of the tube may be square to accommodate comfortable gripping by a user while the outer cross-sectional profile at its proximal region may be circular to accommodate a threaded region coupling means.

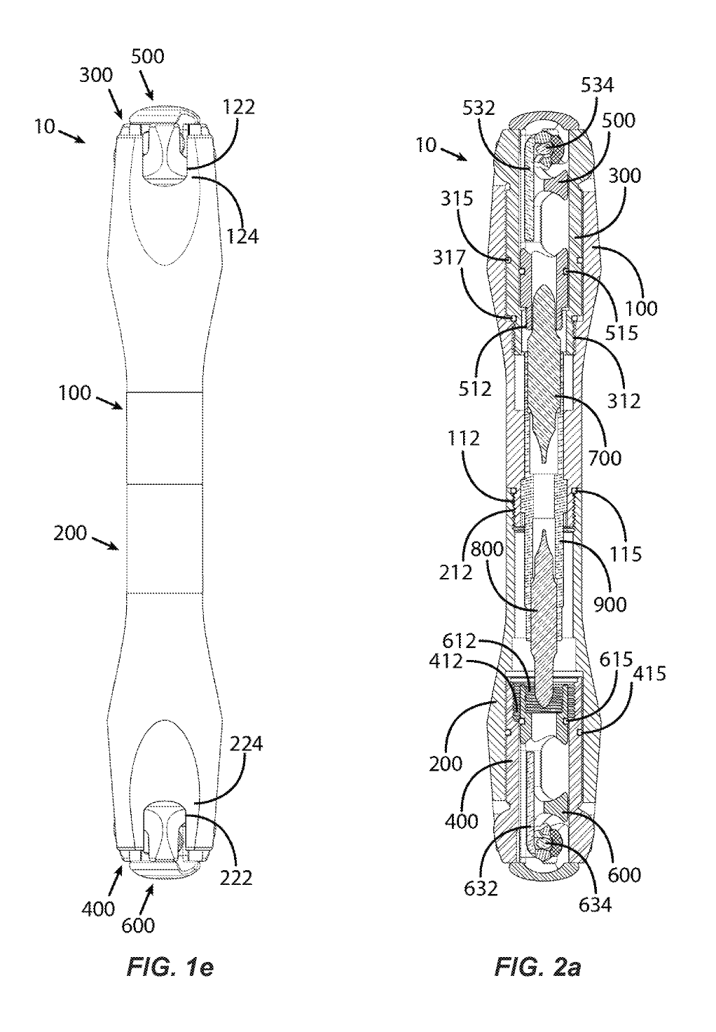

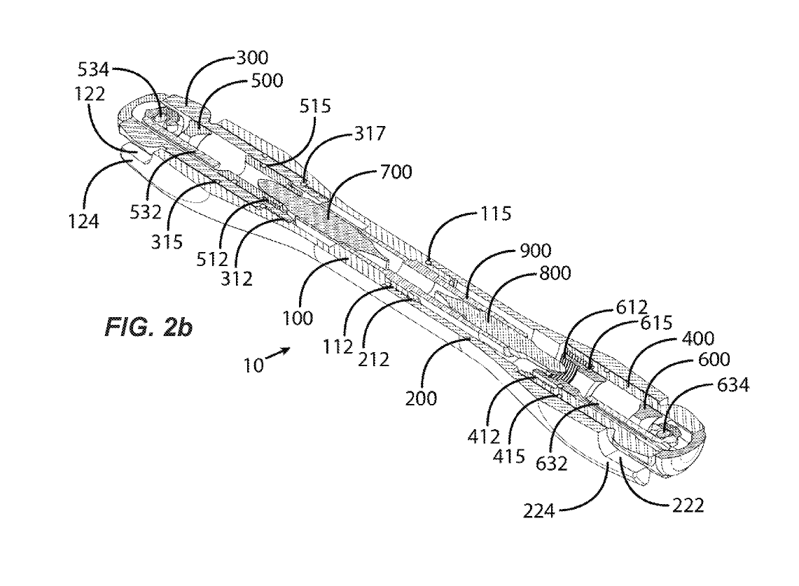

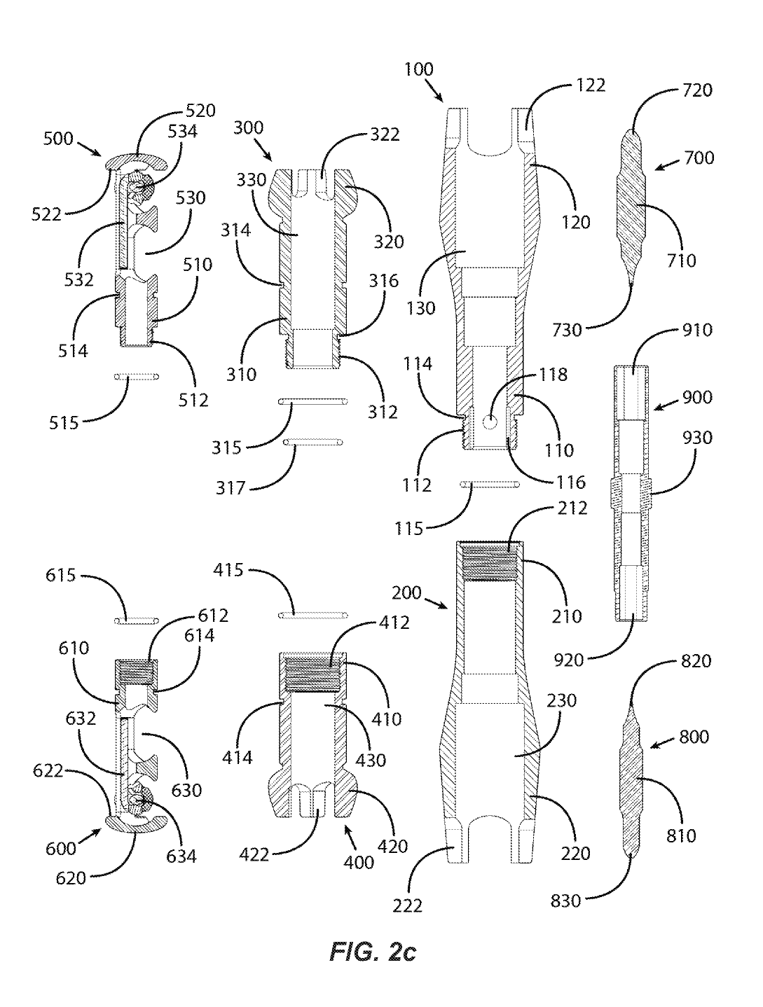

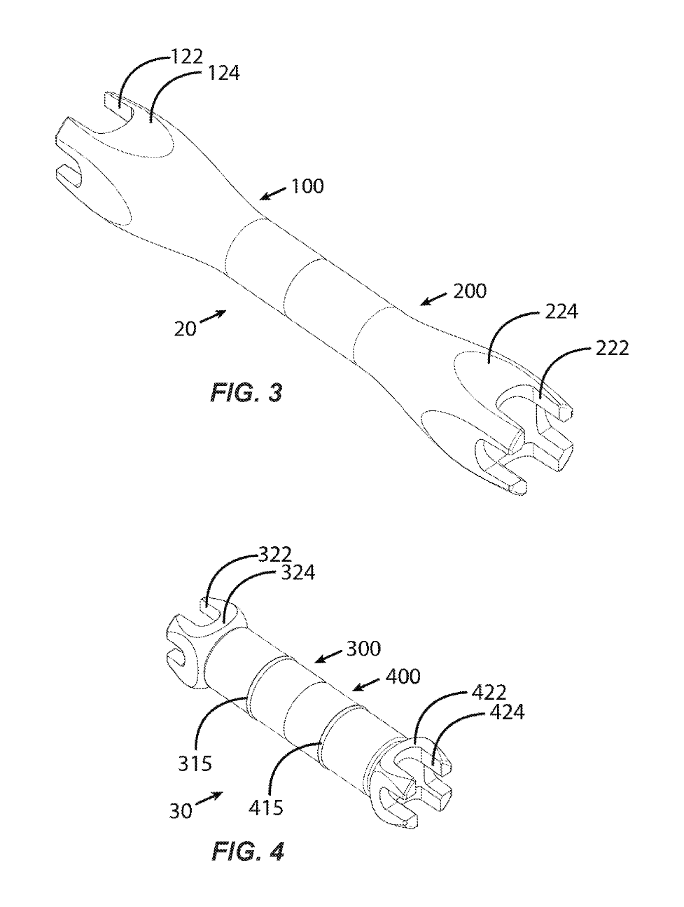

As shown in FIG. 3, the outer wrench assembly 20 comprises the first outer wrench unit 100 and the second outer wrench unit 200 coupled to each other by a coupling means. This coupling means may comprise a male thread of first outer wrench unit 112 disposed on a proximal end of first outer wrench unit 110 and a female thread of second outer wrench unit 212 disposed on a proximal end of second outer wrench unit 210 as fully labeled in FIG. 2c and as shown more clearly in FIGS. 1c-1d and 2a-2b. An o-ring of first outer wrench unit 115 may be disposed within an annular groove of first outer wrench unit 114 to implement an elastomeric bumper and/or frictional element between the proximal end of first outer wrench unit 110 and the proximal end of second outer wrench unit 210 when such ends are coupled.

As shown in FIG. 4, the inner wrench assembly without laser and flashlight 30 comprises the first inner wrench unit 300 and second inner wrench unit 400 coupled to each other by a coupling means. This coupling means may comprise a male thread of first inner wrench unit 312 disposed on a proximal end of first inner wrench unit 310 and a female thread of second inner wrench unit 412 disposed on a proximal end of second inner wrench unit 410 as fully labeled in FIG. 2c and as shown more clearly in FIGS. 1c-1d. A second o-ring of first inner wrench unit 317 may be disposed within a second annular groove of first inner wrench unit 316 to implement an elastomeric bumper and/or frictional element between the proximal end of first inner wrench unit 310 and the proximal end of second inner wrench unit 410 when such ends are coupled.

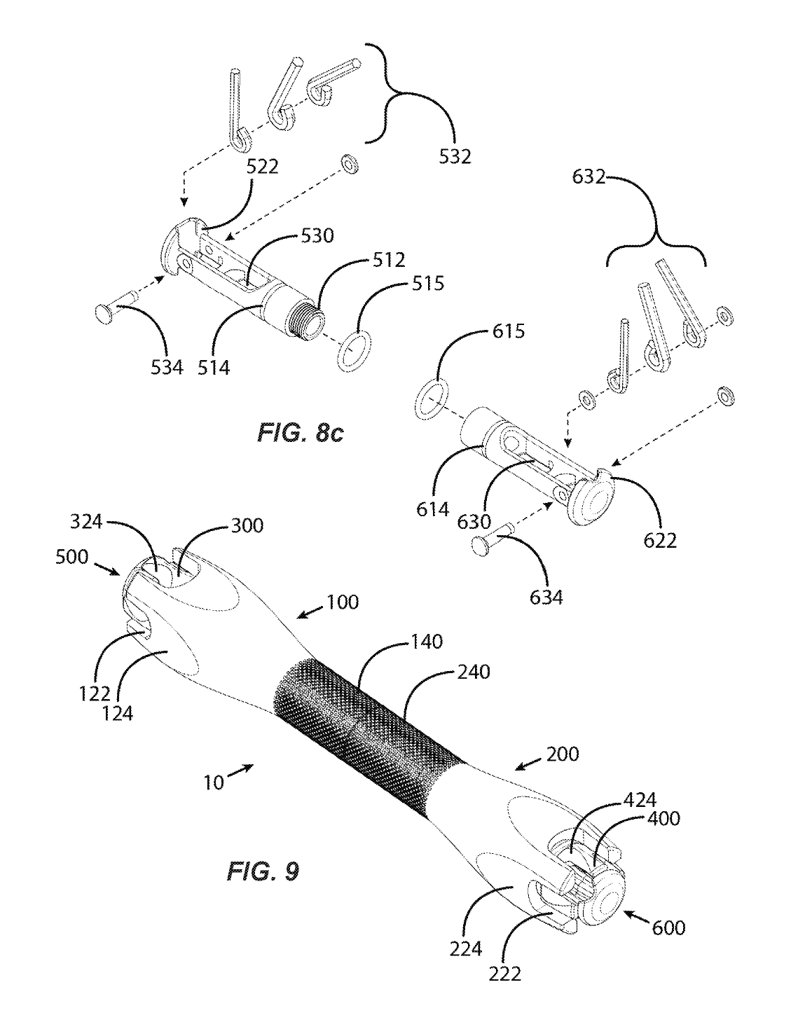

As shown in FIGS. 8a-8b, the hex keys unit assembly 40 comprises the first hex keys unit 500 and second hex keys unit 600 coupled to each other by a coupling means. This coupling means may comprise a male thread of first hex keys unit 512 disposed on a proximal end of first hex keys unit 510 and a female thread of second hex keys unit 612 disposed on a proximal end of second hex keys unit 610 as fully labeled in FIG. 2c and as shown more clearly in FIGS. 1c-1d. An o-ring, not illustrated in the various embodiment, may be disposed within an annular groove adjacent to the male thread of first hex keys unit 512 to implement an elastomeric bumper and/or frictional element between the proximal end of first hex keys unit 510 and the proximal end of second hex keys unit 610 when such ends are coupled.

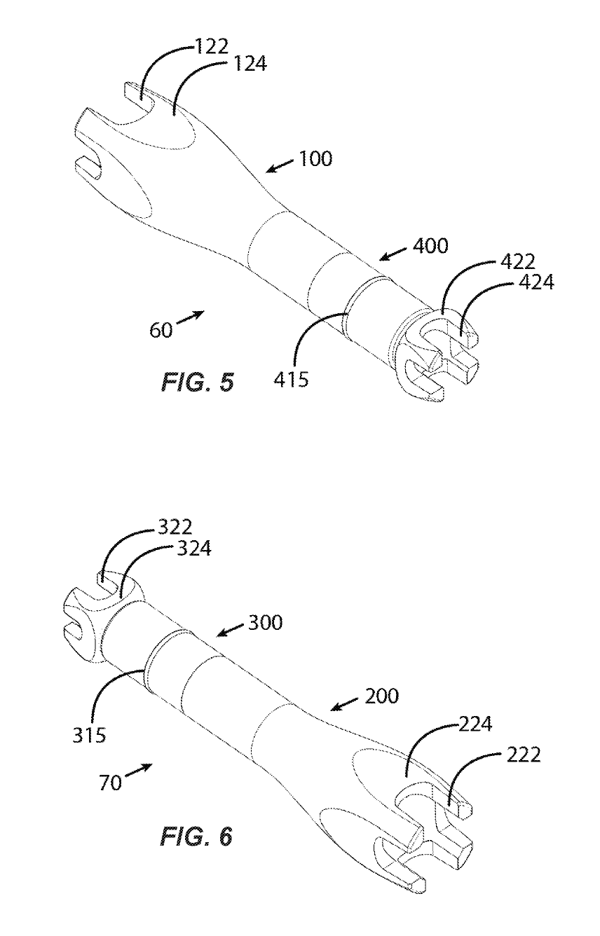

As shown in FIG. 5, the first outer and second inner wrenches assembly 60 comprises the first outer wrench unit 100 coupled to the second inner wrench unit 400, and as shown in FIG. 6 the second outer and first inner wrenches assembly 70 comprises the second outer wrench unit 200 coupled to the first inner wrench unit 300. In this embodiment these assemblies are achievable, respectively, when the male thread of first outer wrench unit 112 is compatible with the female thread of second inner wrench unit 412 and the female thread of second outer wrench unit 212 is compatible with the male thread of first inner wrench unit 312.

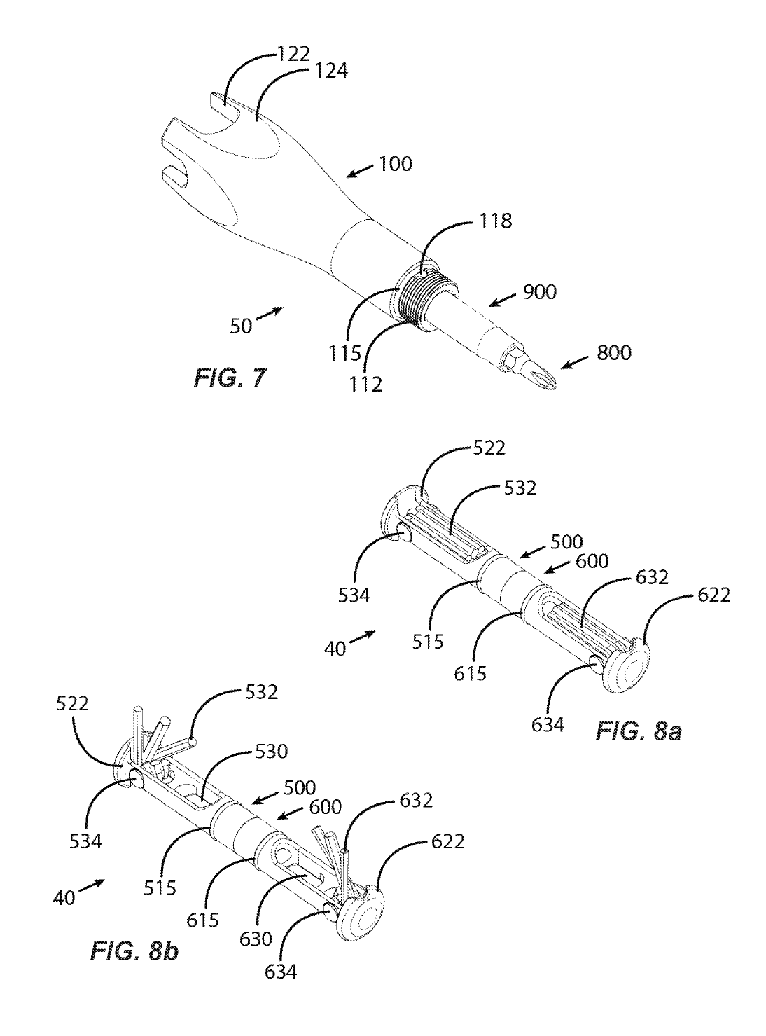

As shown in FIG. 7 and fully labeled in FIGS. 1c-1d and 2c the screwdriver assembly 50 comprises the first outer wrench unit 100 coupled to a screwdriver shaft 900. This coupling means may comprise a ball detent of screwdriver shaft 940 that seats within a through hole of first outer wrench unit 118 (or within a non-through hole interior recess or simply against the interior surface of the first outer wrench unit 100 to impede relative translational motion, and at least one tab of screwdriver shaft 940 that seats within a channel slot of first outer wrench unit 116 to restrict relative rotational motion.

Further, as shown in FIG. 7 and fully labeled in FIGS. 1c-1d and 2c, the screwdriver shaft 900 may be coupled to a second screwdriver bit 800. This coupling means may comprise a ball detente of second screwdriver bit 840 that presses against an interior surface of a second hexagonal bore of screwdriver shaft 920 to impede relative translational motion, and a hexagonal body of second screwdriver bit 810 that engages with the second hexagonal bore of screwdriver shaft 920 to restrict relative rotational motion.

Further, not visible in FIG. 7 but fully labeled in FIGS. 1c-1d and 2c, the screwdriver shaft 900 may be coupled to a first screwdriver bit 700. This coupling means may comprise a ball detente of first screwdriver bit 740 that presses against an interior surface of a first hexagonal bore of screwdriver shaft 910 to impede relative translational motion, and a hexagonal body of first screwdriver bit 710 that engages with the first hexagonal bore of screwdriver shaft 910 to restrict relative rotational motion.

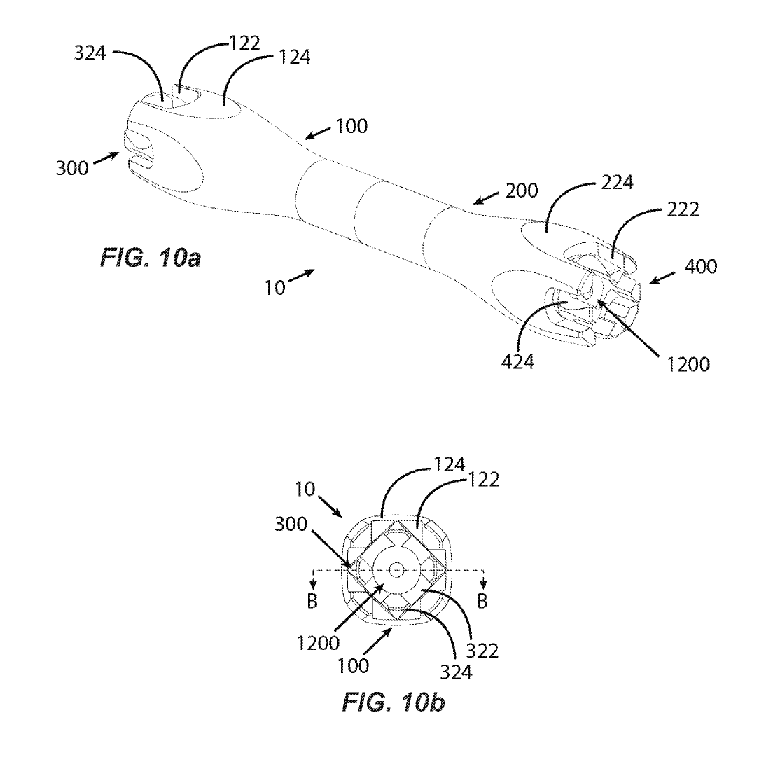

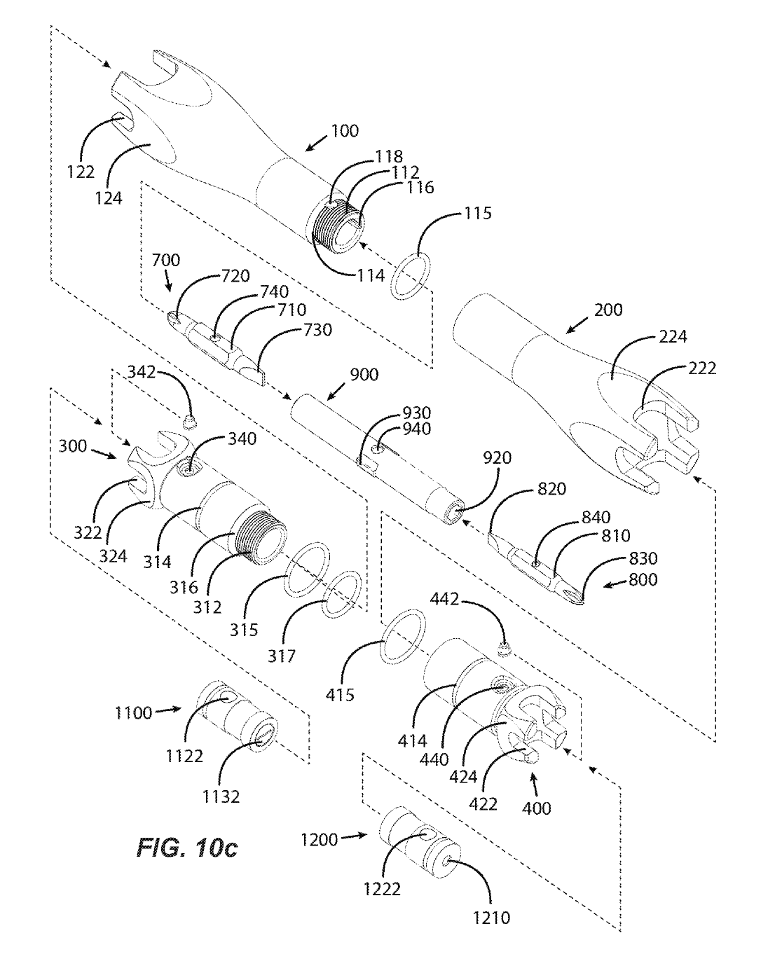

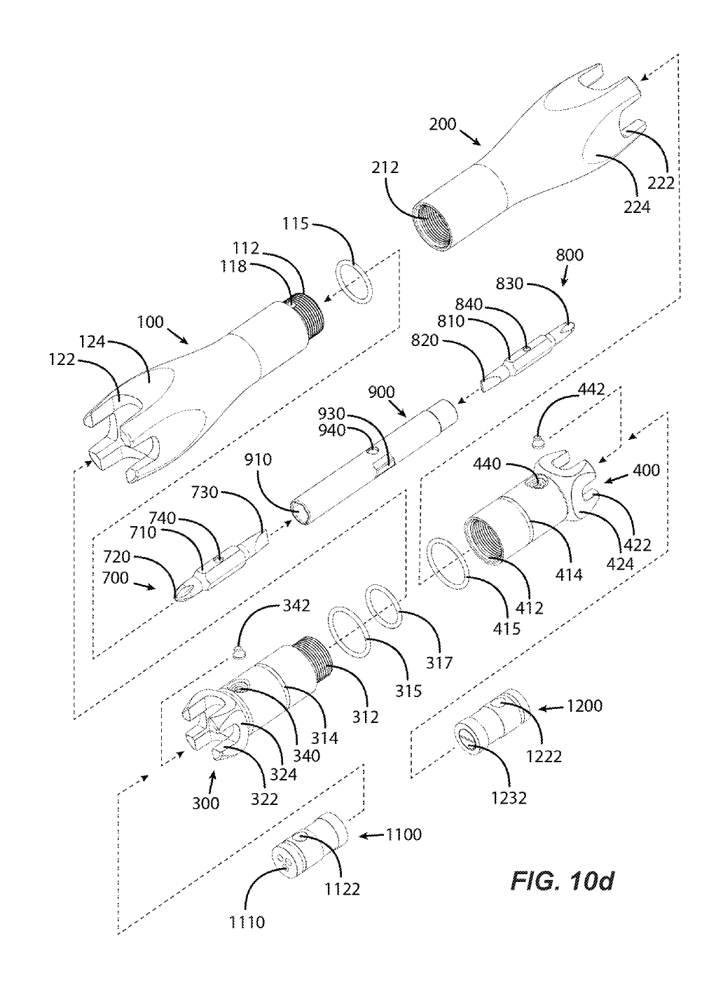

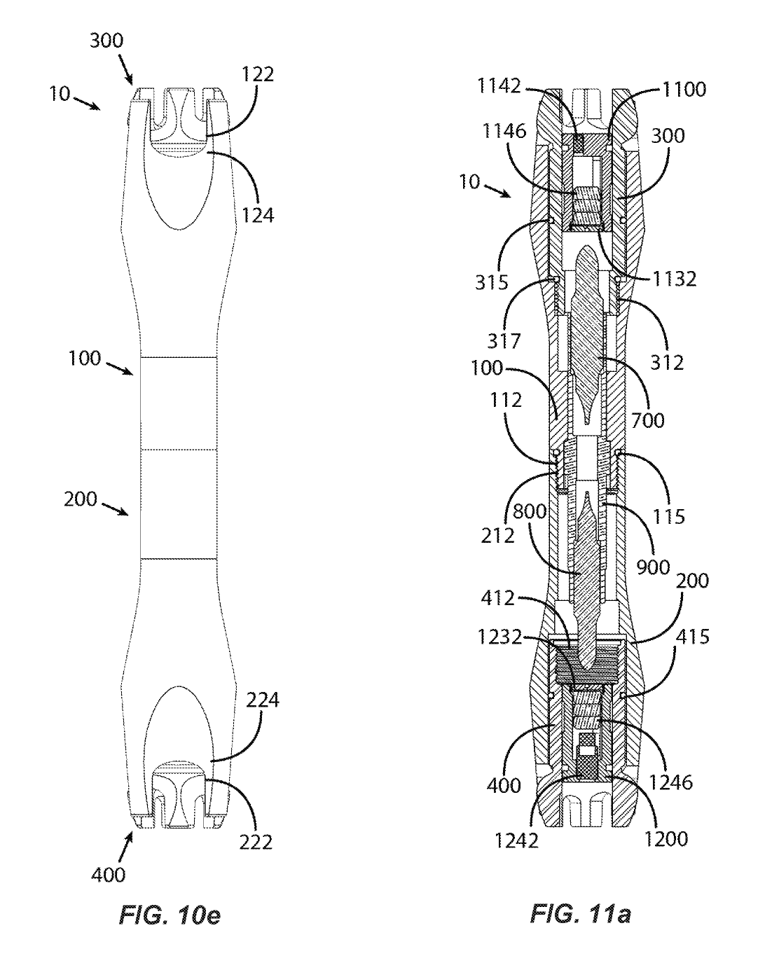

As shown in FIGS. 2c and 10c-10d, the first screwdriver bit 700 may have a first tip of first screwdriver bit 710 and a second tip of first screwdriver bit 720, each of which may be adapted to communicate with an arbitrary fastener or screw-drive type, for example Phillips, slotted, square, Torx, and so on. Similarly, the second screwdriver bit 800 may have a first tip of second screwdriver bit 810 and a second tip of second screwdriver bit 820, each of which may be adapted to communicate with an arbitrary fastener or screw-drive type, for example Phillips, slotted, square, Torx, and so on.

Although there are coupling means that may engage via translation (e.g., o-ring, magnet, detente ball) and some via engage rotation (e.g., threaded portions), such translational and rotational engagements may be interchangeable. For example, the o-ring that implements a frictional fit of the first inner wrench unit 300 against the interior of the first outer wrench unit 100 may be preferred in some circumstances because it permits a bulbous distal end of first inner wrench unit 320 having an outer diameter greater than the inner diameter of the distal end of first outer wrench unit 120 to nest within the wrench openings of first outer wrench unit 122. In contrast, this would not be possible if threaded portions were used as the coupling means, for example male thread on the exterior of the first inner wrench unit 300 and female thread on the interior of the first outer wrench unit 100.

As shown in FIGS. 1a-1e, 2b-2c, and 3 and fully labeled in FIG. 2c, disposed on the distal end of first outer wrench unit 120 is at least one wrench opening of first outer wrench unit 122 having a substantially flat wrench face of first outer wrench unit 124 and configured to interface with a nut, bolt, or other fastener, and disposed on the distal end of second outer wrench unit 220 is at least one wrench opening of second outer wrench unit 222 having a substantially flat wrench face of second outer wrench unit 224 and configured to interface with a nut, bolt, or other fastener.

As shown in FIGS. 1d and 4 and fully labeled in FIG. 2c, disposed on the distal end of first inner wrench unit 320 is at least one wrench opening of first inner wrench unit 322 having a substantially flat wrench face of first inner wrench unit 324 and configured to interface with a nut, bolt, or other fastener, and disposed on the distal end of second inner wrench unit 420 is at least one wrench opening of second inner wrench unit 422 having a substantially flat wrench face of second inner wrench unit 424 and configured to interface with a nut, bolt, or other fastener.

As shown in FIGS. 8a-8c and fully labeled in FIG. 2c, disposed within or adjacent to a cavity of first hex keys unit 530 is a swivel pin of first hex keys unit 534 to which at least one hex key of first hex keys unit 532 may be attached and about which the hex key of first hex keys unit 532 may pivot, and disposed within or adjacent to a cavity of second hex keys unit 630 is a swivel pin of second hex keys unit 634 to which at least one hex key of second hex keys unit 632 may be attached and about which the hex key of second hex keys unit 632 may pivot.

FIGS. 1c and 1d show exploded views of the tool assembly 10. A first o-ring of first inner wrench unit 315 may be disposed within a first annular groove of first inner wrench unit 314 to implement a frictional fit when the first inner wrench unit 300 is nested within the first outer wrench unit 100, and similarly an o-ring of second inner wrench unit 415 may be disposed within an annular groove of second inner wrench unit 414 to implement a frictional fit when the second inner wrench unit 400 is nested within the second outer wrench unit 200. FIG. 4 shows these o-rings disposed in their respective grooves.

Similarly, an o-ring of first hex keys unit 515 may be disposed within an annular groove of first hex keys unit 514 to create a frictional fit when the first hex keys unit 500 is nested within the first inner wrench unit 300, and similarly an o-ring of second hex keys unit 615 may be disposed within an annular groove of second hex keys unit 614 to create a frictional fit when the second hex keys unit 600 is nested within the second inner wrench unit 400. FIG. 8a shows these o-rings in their respective grooves.

Cross-nesting of the various units, for example the second inner wrench unit 400 nesting within the first outer wrench unit 100 or the second hex keys unit 600 nesting within the first inner wrench unit 300, may be achievable if the inner and outer diameters of the respectively swapped units are substantially similar.

As shown in FIGS. 2c and 8a-8c, the distal end of first hex keys unit 520 may define a flange of first hex keys unit 522 to prevent the first hex keys unit 500 from being inserted (nested) to deeply within the first inner wrench unit 300. Similarly, the distal end of second hex keys unit 620 may define a flange of second hex keys unit 622 to prevent the second hex keys unit 600 from being inserted (nested) to deeply within the second inner wrench unit 400. Such flanges may also function as a gripping member when a user desires to remove (de-nest) a hex keys unit from an inner wrench unit.

FIG. 9 shows the tool assembly 10 having a knurling of first outer wrench unit 140 and a knurling of second outer wrench unit 240 which may be provide a grip for a user, which could be especially important when using the screwdriver assembly 50.

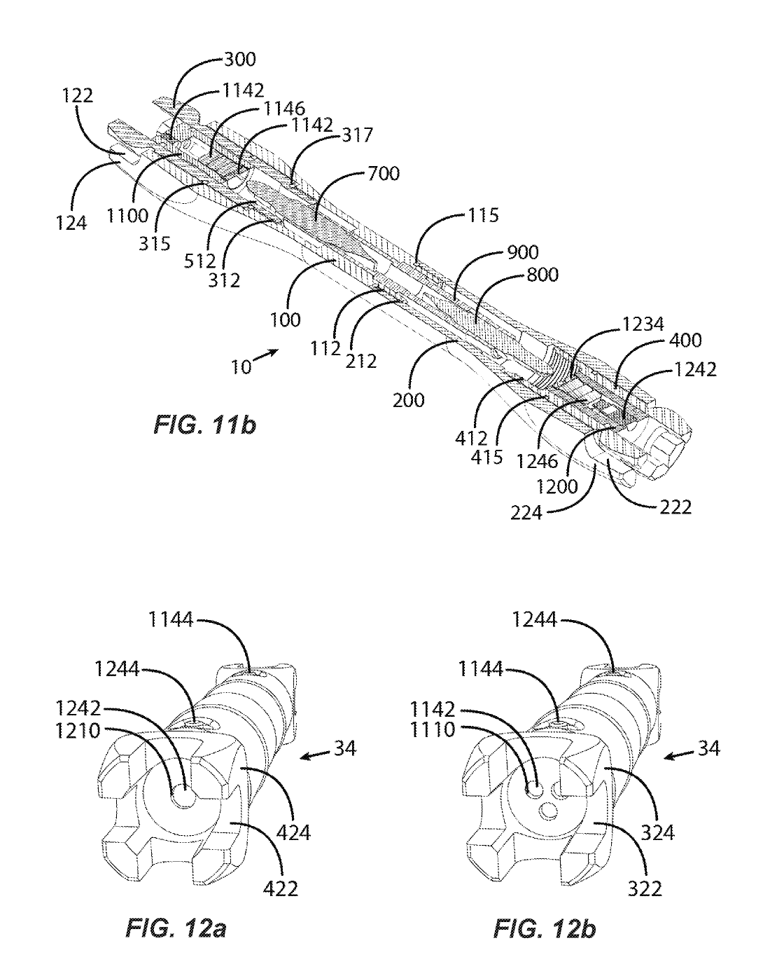

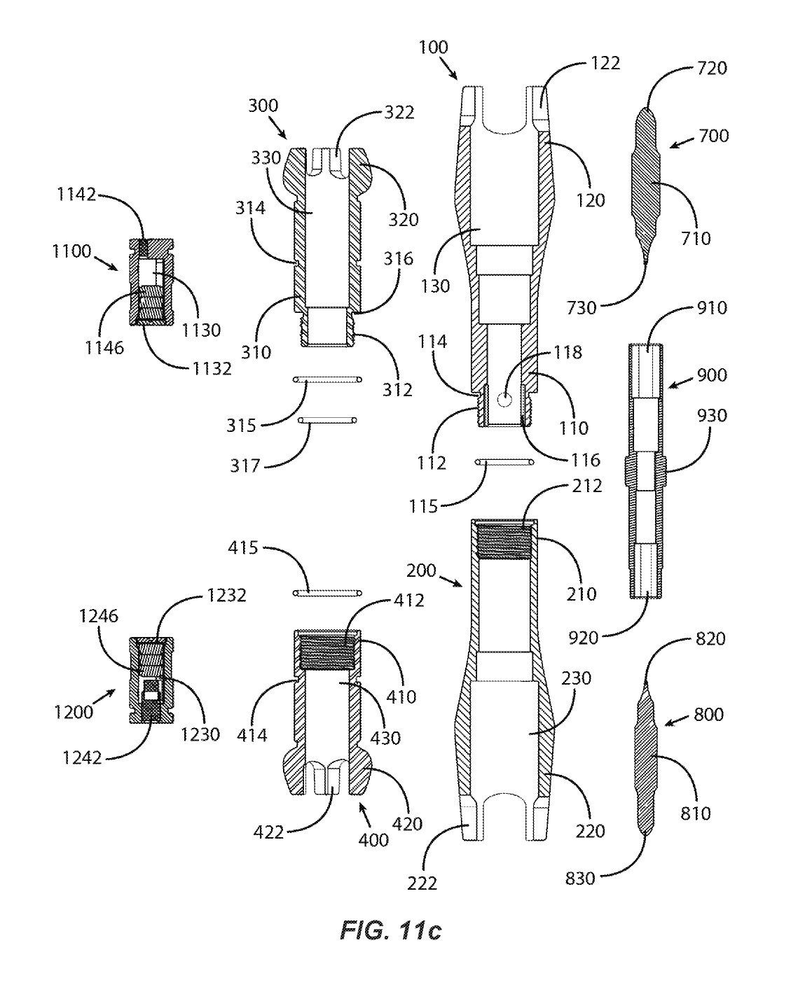

FIG. 10a shows a second embodiment of the tool assembly 10 in a fully nested configuration, FIG. 10d shows an exploded view thereof, and FIG. 11c shows an exploded cross-sectional view thereof. This second embodiment is substantially similar to the first embodiment, so only the differences will be described herein. Specifically, in place of the first hex keys unit 500 is a flashlight unit 1100 (not visible in FIG. 10a but visible in FIG. 10c) which is press-fit within the through bore of first inner wrench unit 330 of the generally tubular first inner wrench unit 300 which is in turn nested within the through bore of first outer wrench unit 130 of the generally tubular first outer wrench unit 100. Similarly, in place of the second hex keys unit 600 is a laser unit 1200 which is press-fit within the through bore of second inner wrench unit 430 of the generally tubular second inner wrench unit 400 which is in turn nested within the through bore of second outer wrench unit 230 of the generally tubular second outer wrench unit 200.

FIG. 10b shows an end elevation of the fully nested tool assembly 10 wherein the laser unit 1200 press-fit within the first inner wrench unit 300 which is in turn nested within the first outer wrench unit 100.

As indicated earlier in reference to the first embodiment, the generally tubular nested units may have any arbitrary cross-sectional interior and exterior profiles. Further, the term press-fit in this second embodiment has been substituted for the term nesting in certain instances to indicate that it may be desirable for the flashlight unit 1100 and the laser unit 1200 to semi-permanently reside within the first inner wrench unit 300 and the second inner wrench unit 400, respectively. Removal thereof may only be desired for maintenance or repair. Although not illustrated in the several figures, such press-fit could be implemented by means of an o-ring, or by any other suitable coupling means.

FIGS. 10e and 11a show the fully nested tool assembly 10. As shown in the cross-section of FIGS. 11a-11b and respectively in FIGS. 12a-12b, there is an axial separation between the distal end of the flashlight unit 1100 and the wrench openings of first inner wrench unit 322 to provide adequate clearance between the flashlight unit 1100 and a nut, bolt, or other fastener when using the wrench opening of first inner wrench unit 322. Similarly, there is an axial separation between the distal end of the laser unit 1200 and the wrench openings of second inner wrench unit 422 to provide adequate clearance between the laser unit 1200 and a nut, bolt, or other fastener when using the wrench opening of second inner wrench unit 422.

Alternatively, the flashlight unit 1100 and the laser unit 1200 could simply be nested within first inner wrench unit 300 and the second inner wrench unit 400, respectively, wherein they must be removed prior to using the wrench opening of first inner wrench unit 322 and the wrench opening of second inner wrench unit 422, respectively. This could be achieved by adapting the first hex keys unit 500 to house the electronics assembly of flashlight unit 1140 within the cavity of first hex keys unit 530, and adapting the second hex keys unit 700 to house the electronics assembly of laser unit 1240 within the cavity of second hex keys unit 630, respectively.

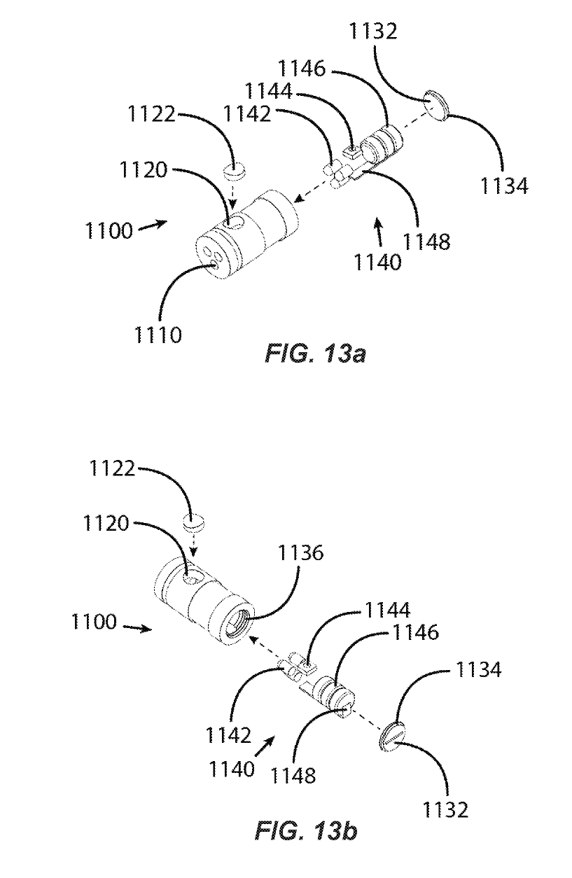

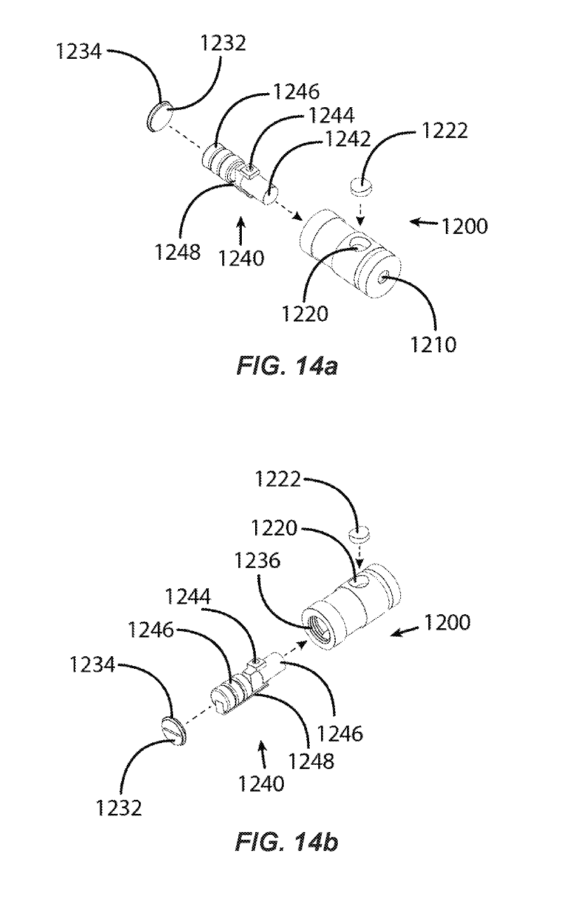

As shown in FIG. 10d, the first inner wrench unit 300 includes a button hole of first inner wrench unit 340 into which a button of first inner wrench unit 342 is disposed. The button of first inner wrench unit 342 communicates with a button of flashlight unit 1122, which itself is disposed within a button hole of flashlight unit 1120 as shown in FIG. 13a-13b, to activate or deactivate the flashlight unit 1100. Similarly, the second inner wrench unit 400 includes a button hole of second inner wrench unit 440 into which a button of second inner wrench unit 442 is disposed. The button of second inner wrench unit 442 communicates with a button of laser unit 1222, which itself is disposed within a button hole of laser unit 1220 as shown in FIG. 14a-14b, to activate or deactivate the laser unit 1200.

The flashlight unit 1100 may include an electronics assembly of flashlight unit 1140 disposed within a cavity of flashlight unit 1130 comprising a bulb of flashlight unit 1142, an electronic push button switch of flashlight unit 1144, at least one battery of flashlight unit 1146, and an electric lead of flashlight unit 1148 to complete an electrical circuit when the button of flashlight unit 1122 is actuated. An end cap of flashlight unit 1132 having a male thread of flashlight unit 1134 may couple with a female thread of flashlight unit 1136 to at least partially enclose the electronics assembly of flashlight unit 1140 within the cavity of flashlight unit 1130. The bulb of flashlight unit 1142 may be disposed adjacent to a bulb hole of flashlight unit 1110.

Similarly, The laser unit 1200 may include an electronics assembly of laser unit 1240 disposed within a cavity of laser unit 1230 comprising a laser of laser unit 1242, an electronic push button switch of laser unit 1244, at least one battery of laser unit 1246, and an electric lead of laser unit 1248 to complete an electrical circuit when the button of laser unit 1222 is actuated. An end cap of laser unit 1232 having a male thread of laser unit 1234 may couple with a female thread of laser unit 1236 to at least partially enclose the electronics assembly of laser unit 1240 within the cavity of laser unit 1230. The laser of laser unit 1242 may be disposed adjacent to a laser hole of laser unit 1210.

Many modifications, configurations, and features may be evident that do not depart from the spirit and scope of the present invention. Although specific embodiments have been illustrated and described, it should be understood that the embodiments are exemplary, non-exhaustive, and should not limit the scope of the present invention as defined by the appended claims.

What is claimed is:

1. A tool comprising:
(a) a first outer tube having
(1) a first outer-tube distal end having a first outer-tube distal inner diameter and a plurality of open slots, and
(2) a first outer-tube proximal end having a first outer-tube proximal inner diameter;
(b) a second outer tube having
(1) a distal end having a second outer-tube distal inner diameter and a plurality of open slots, and
(2) a second outer-tube proximal end having a second outer-tube proximal inner diameter; and
(c) an outer-outer coupling means for securing the first outer-tube proximal end to the second outer-tube proximal end.

2. The tool of claim 1 further comprising:
(a) a shaft having
(1) an outer diameter smaller than the first outer-tube proximal inner diameter and smaller than the second outer-tube proximal inner diameter, and
(2) a first polygonal axial bore on a first end;
(b) a shaft-outer coupling means for securing the shaft to the interior of the first outer-tube proximal end and restricting relative rotation thereof;
(c) a first screwdriver bit having a first tip on a first end and a polygonal body complementary to the first polygonal axial bore; and
(d) a first bit-shaft coupling means for securing the first screwdriver bit within the first polygonal bore.

3. The tool of claim 2 further comprising:
(a) the shaft having a second polygonal axial bore on a second end;
(b) a second screwdriver bit having a first tip on a first end and a polygonal body complementary to the second polygonal axial bore; and
(c) a second bit-shaft coupling means for securing the second screwdriver bit within the second polygonal bore.

4. The tool of claim 3 further comprising:
(a) a first inner tube having
(1) a first inner-tube distal end having a first inner-tube distal inner diameter and a plurality of open slots, and
(2) a first inner-tube proximal end having a first inner-tube proximal outer diameter smaller than the first outer-tube distal inner diameter;
(b) a first inner-outer coupling means for securing the first inner tube within the first outer tube;
(c) a second inner tube having
(1) a second inner-tube distal end having a second inner-tube distal inner diameter and a plurality of open slots, and
(2) a second inner-tube proximal end having a second inner-tube proximal outer diameter smaller than the second outer-tube distal inner diameter;
(d) a second inner-outer coupling means for securing the second inner tube within the second outer tube; and
(e) an inner-inner coupling means for securing the first inner-tube proximal end to the second inner-tube proximal end.

5. The tool of claim 4 wherein the
(a) the first outer-tube proximal end may couple with the second inner-tube proximal end; and
(b) the second outer-tube proximal end may couple with the first inner-tube proximal end.

6. The tool of claim 5 further comprising:
(a) the second inner tube having
(1) a laser unit mounted therein comprising a laser, a battery, and an electrical switch, and
(2) a means for a user to communicate with the electrical switch of the laser unit.

7. The tool of claim 6 further comprising:
(a) the first inner tube having
(1) a flashlight unit mounted therein comprising a bulb, a battery, and an electrical switch, and
(2) a means for a user to communicate with the electrical switch of the flashlight unit.

8. The tool of claim 5 further comprising:
(a) a third inner tube having
(1) a third inner-tube proximal end having a third inner-tube proximal outer diameter smaller than the first inner-tube distal inner diameter; and
(2) a screw-drive tip.

9. The tool of claim 6 further comprising:
(a) a fourth inner tube having
(1) a fourth inner-tube proximal end having a fourth inner-tube proximal outer diameter smaller than the second inner-tube distal inner diameter; and
(2) a screw-drive tip.

10. A tool comprising:
(a) a first outer tube having
(1) a first outer-tube distal end having a first outer-tube distal inner diameter and a first outer-tube plurality of open slots, and
(2) a first outer-tube proximal end having a first outer-tube proximal inner diameter and a first outer-tube male threaded portion; and
(b) a second outer tube having
(1) a distal end having a second outer-tube distal inner diameter and a second outer-tube plurality of open slots, and
(2) a second outer-tube proximal end with a second outer-tube proximal inner diameter and a first inner-tube female threaded portion adapted to mate with the first outer-tube male threaded portion.

11. The tool of claim 10 further comprising:
(a) a shaft having
(1) an outer diameter smaller than the first outer-tube proximal inner diameter and smaller than the second outer-tube proximal inner diameter,
(2) a first polygonal axial bore on a first end,
(3) a ball plunger on a medial region, and
(4) a radially extending tab on a medial region; and
(b) a first screwdriver bit having
(1) a first tip on a first end,
(2) a polygonal body complementary to the first polygonal axial bore, and
(3) a ball plunger on a medial region.

12. The tool of claim 11 further comprising:
(a) the shaft having a second polygonal axial bore on a second end; and
(b) a second screwdriver bit having
(1) a first tip on a first end,
(2) a polygonal body complementary to the second polygonal axial bore, and
(3) a ball plunger on a medial region.

13. The tool of claim 12 further comprising:
(a) a first inner tube having
(1) a first inner-tube distal end having a first inner-tube distal inner diameter and a first inner-tube plurality of open slots,
(2) a first inner-tube medial region having a first inner-tube medial outer diameter slightly smaller than the first outer-tube distal inner diameter and an o-ring disposed thereon, and
(3) a first inner-tube proximal end with a first inner-tube proximal outer diameter smaller than the first outer-tube distal inner diameter and having a first inner-tube male threaded portion; and
(b) a second inner tube having
(1) a second inner-tube distal end having a second inner-tube distal inner diameter and a second inner-tube plurality of open slots,
(2) a second inner-tube medial region having a second inner-tube medial outer diameter slightly smaller than the second outer-tube distal inner diameter and an o-ring disposed thereon, and
(3) a second inner-tube proximal end with a second inner-tube proximal outer diameter smaller than the second outer-tube distal inner diameter and having a second inner-tube female threaded portion adapted to mate with the first inner-tube male threaded portion.

14. The tool of claim 13 wherein:
(a) the first outer-tube male threaded portion can mate with the second inner-tube female threaded portion; and
(b) the second outer-tube female threaded portion can mate with the first inner-tube male threaded portion.

15. The tool of claim 14 further comprising:
(a) the second inner tube having
(1) a laser unit press fit therein comprising a laser, a battery, and an electrical switch, and
(2) a button disposed within a wall adjacent to the electrical switch of the laser unit.

16. The tool of claim 15 further comprising:
(a) the first inner tube having
(1) a flashlight unit mounted therein comprising a bulb, a battery, and an electrical switch, and
(2) a button disposed within a wall adjacent to the electrical switch of the flashlight unit.

17. The tool of claim 14 further comprising:
(a) a third inner tube having
(1) a third inner-tube proximal end having a third inner-tube proximal outer diameter smaller than the first inner-tube distal inner diameter; and
(2) a screw-drive tip.

18. The tool of claim 17 further comprising:
(a) a fourth inner tube having
(1) a fourth inner-tube proximal end having a fourth inner-tube proximal outer diameter smaller than the second inner-tube distal inner diameter; and
(2) a screw-drive tip.
